(19) United States
(12) Patent Application Publication
(10) Pub. No.: US 2008/0015744 A1
(43) Pub. Date: Jan. 17, 2008

(54) REMOTED CONTROLLED VEHICLE SYSTEM

(76) Inventor: Isaac Lund, Irvine, CA (US)

Correspondence Address: MANUEL F. DE LA CERRA, 6885 CATAMARAN DRIVE, CARLSBAD, CA, 92011, US

(21) Appl. No.: 11/457,815

(22) Filed: Jul. 17, 2006

(51) Int. Cl. B60T 8/32

(52) U.S. Cl. 701/2; 701/93

(57) ABSTRACT

A novel system and method for providing remote control of a vehicle is disclosed. The system comprises an antenna, a central processing unit, a speed sensor, a speed control device, and optionally, a transmission disengagement device. By sending a remote control signal to the vehicle, the vehicle can be slowed or completely stopped by cutting off power to the vehicle's drive train. The remote control signal can be keyed uniquely to a single vehicle or a small group of vehicles, such that only those vehicles in the group respond to the signal. The device and methods disclosed herein may be used in high speed pursuits to disable a vehicle and force it to a peaceful stop. The device and methods disclosed herein may also be used in safety zones such as construction areas or school zones to protect pedestrians.

### FIELD OF THE INVENTION

The present invention relates to the personal vehicles, and more specifically, to the remote control of certain aspects of a personal vehicle.

### BACKGROUND OF THE INVENTION

According to the National Highway Traffic Safety Administration, in 2003, California's 7,171 high-speed pursuits (HSP) caused 51 deaths, 18 of which were innocent bystanders. National statistics from 1982 to 2004 show that 7,430 deaths resulted from police HSP. While occupants of the chased vehicles accounted for most of those deaths, nearly 2,000 uninvolved motorists and bystanders also died.

The epidemic of HSP has promptly several jurisdictions to propose new legislation aimed at curbing the incident of these pursuits. For example, under California's current law a police officer is immune from civil liability if that officer is involved in a HSP. California legislators have proposed legislation that removes the officer's immunity; thus, an officer could be held civilly liable for damages caused during a HSP.

While the proposed legislation may reduce the number of HSP, it does not solve the root cause of the problem. In fact, it is likely that more perpetrators would attempt to evade the police if they know that the police will not pursue. Ultimately, this may result in fewer HSP, while simultaneously rewarding criminals.

Three commonly available techniques for stopping a HSP in progress are pit maneuvers, bumping and spike strips. To successfully execute a pit maneuver, the police officer attempts to create a pit out of other vehicles and/or obstacles to slow down and stop the evading vehicle. The officer may use other police officers that are ahead of the pursuit and “box” the evading vehicle, or the officer may ask for assistance for non-law enforcement—specifically semi-trailer trucks to help in “boxing” the evading vehicle. In bumping, the police officer may bump the backend of the evading vehicle causing it to careen out of control and crash. Finally, a spike strip may be placed in front of the evading vehicle, causing its tires to blow out and making the vehicle much more difficult to control.

These techniques, however, have their shortcomings. First, the pit maneuver requires several players placed in a precise formation. This places several players in harm's way and it may not be feasible to execute one of these maneuvers in high-traffic areas. Also, the evading vehicle may become more erratic attempting to evade being “boxed” in. Bumping can be very dangerous to the occupants of the evading vehicle, the police officer executing the maneuver and any bystanders. Also, bumping does not guarantee that the vehicle will be stopped. Finally, the spike strip requires that the roadway ahead of the pursuit be relatively cleared so that the spike strip can be applied. Again, this may not be feasible in a high-traffic area. Nor does the spike strip disable the vehicle from continuing to evade police. In fact, the evading vehicle can continue the pursuit, but in a condition that makes it more erratic and less easily controlled.

What is needed, therefore, is a system that safely slows down a vehicle to a stop during a HSP.

### SUMMARY OF THE INVENTION

The object of the present system is to provide a means for remotely controlling a vehicle by either reducing its speed or completely cutting off power to the vehicle's drive train. The system comprises an antenna, a central processing unit, a speed sensor and a speed control device. Optionally, it may also include a transmission disengagement device.

In one embodiment, the remote control signal may simply require that the vehicle slow down, which would be implemented by the CPU sending to the speed control device a signal to reduce the vehicle's speed. The CPU would constantly monitor its present speed (as determined by the speed sensor) against the speed encoded in the remote control signal until the encoded speed is attained. This embodiment may be useful in safety zones, such as construction areas and school zones, where reduced speeds can save lives.

In another embodiment, remote control signal requires that the vehicle completely stop. The CPU in this case could send one or both of the following signals: a signal to the speed control device to completely cut off the fuel and/or air to the engine (thus stalling the engine) or a signal to the transmission disengagement device to disengage the transmission from the engine. This embodiment would be particularly useful in HSP where the evading vehicle needs to be stopped and its occupants apprehended.

In yet another embodiment, the remote controlled signal is keyed uniquely to a single vehicle or a small group of vehicles, such that only those vehicles in the group respond to the signal. This is especially useful in HSP where it would be optimal to allow innocent vehicle the speed and control to avoid an accident, while simultaneously selectively controlling the evading vehicle.

### BRIEF DESCRIPTION OF THE DRAWINGS

FIG. 1 is an overview of the remote controlled vehicle system.

FIGS. 2A & 2B illustrates the operation of a clutch in a manual transmission system.

FIG. 3 presents a use of the remote controlled vehicle system in a school zone.

FIG. 4 is a flowchart that illustrates the operation of the central processing unit in response to a remote control signal.

### DETAILED DESCRIPTION OF THE INVENTION

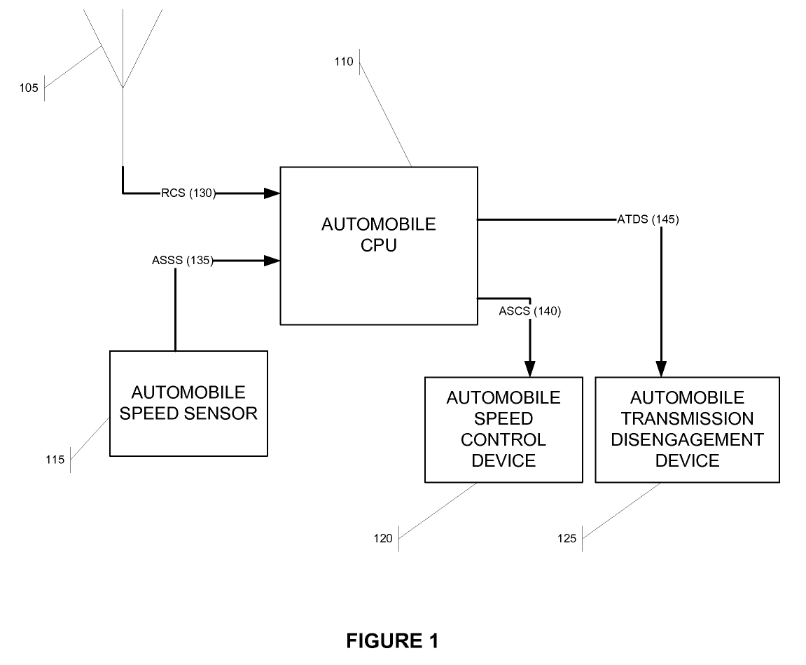

What is described below is a novel system that can slow or stop vehicles remotely. This system can be especially useful in HSP to bring an evading vehicle to a safe stop without endangering bystanders. FIG. 1 provides an overview of the system described herein. The system may comprise an antenna (105) a central processing unit (CPU) (110), an automobile speed sensor (115), an automobile speed control device (120) and, optionally, an automobile transmission disable device (125). The antenna (105) receives a wireless remote control signal (RCS) which it transmits to the CPU (110), as shown by control line 130. The RCS may include instructions to reduce speed and/or to stop the vehicle. It may also include the duration for which the reduction in speed should be sustained. The RCS is transmitted by a device external to the vehicle and is intended to commandeer a portion of the vehicle's control. For example, the transmitting device may be mobile (such as a police car or helicopter) or stationary.

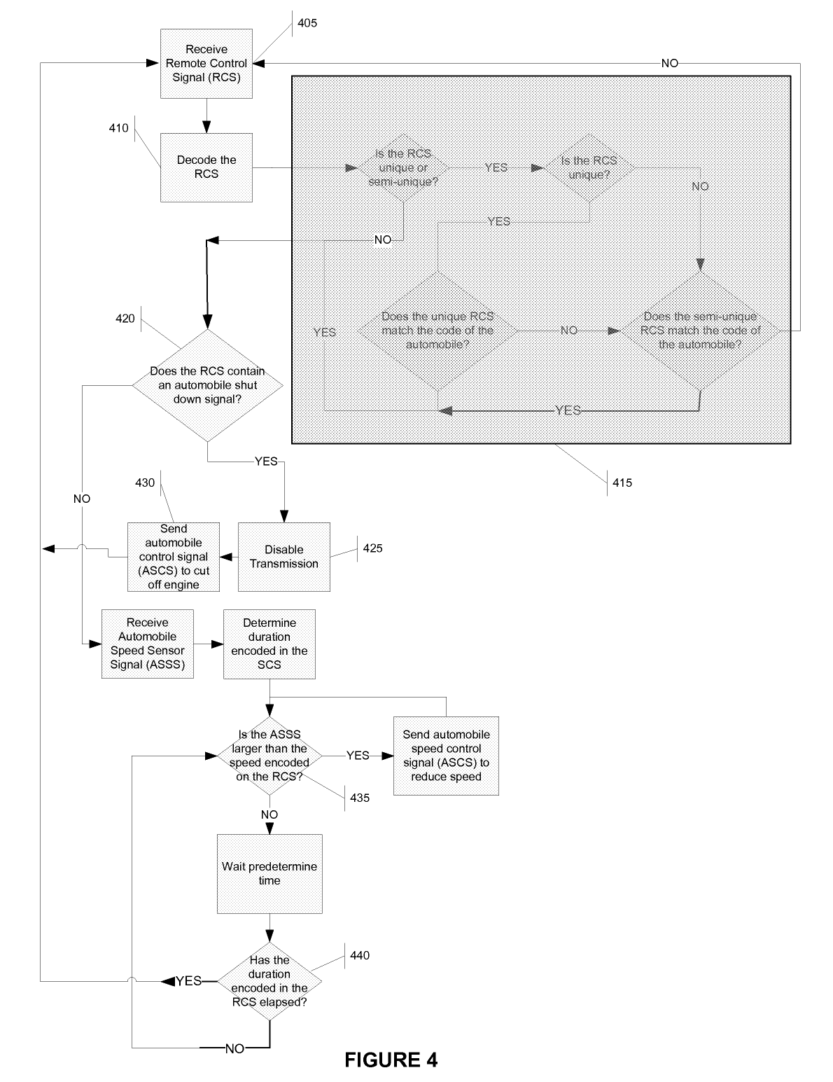

In addition to the RCS (130), the CPU (110) also receives the automobile speed sensor signal (ASSS at control line 135) from the automobile speed sensor. From these two inputs, the CPU (110) can generate an automobile speed control signal (ASCS at control line 140) and/or an automobile transmission disengagement signal (ATDS at control line 145) that control the automobile speed control device (120) and the automobile transmission disengagement device (125), respectively. The automobile speed control device (120) controls the speed of the vehicle in response to the ASCS (140), while the automobile transmission disengagement device (125) disengages the transmission in response to the ATDS (145). Using these two signals either alone or in combination, allows the CPU (110) to slow down a vehicle or completely stop a vehicle in response to the RCS (130). The operation and control of the CPU is described with reference to FIG. 4 below.

Now that an overview of the system has been disclosed the individual components will now be discussed. The automobile speed control device 120 can be implemented in several ways depending on the type of fuel delivery system. In a carburetor system, the throttle valve controls the amount of air and fuel that is allowed into the engine, which control the power output of the engine. As the throttle valve opens, more air is allowed through the carburetor and as more air flows through the carburetor more fuel is entrained into the air and forced into the cylinders. The greater the amount of fuel and air, the more power the engine will produce. A fuel injection system also uses a throttle valve; however, it only determines the amount of air that is allowed into the engine. The fuel delivery is performed by individual fuel injectors in the cylinders of the engine, which are often electronically-controlled meaning that the precise amount of fuel is pumped into each cylinder using an electric pump. By controlling either the throttle valve (in the case of a carbureted system) or controlling the throttle valve and/or the electronic fuel pump, you can manipulate the power output of the engine and, consequently, the speed of the vehicle.

Specifically, in a carbureted system the automobile speed control device may comprise a solenoid, motor or other electromechanical device to close the throttle valve, which will slow the engine down because the engine is being choked of fuel. It is also possible to interrupt the fuel supply by either disengaging the fuel pump or by placing a valve in the fuel line that shuts down the fuel supply in response to a signal.

In an electronic fuel injection system, the throttle valve and the injectors are generally controlled by an existing CPU that sends out signals to optimize the performance of the engine. In this type of fuel system, the automobile speed control device may comprise the existing control systems, but include an override command to slow (or shut) down the engine.

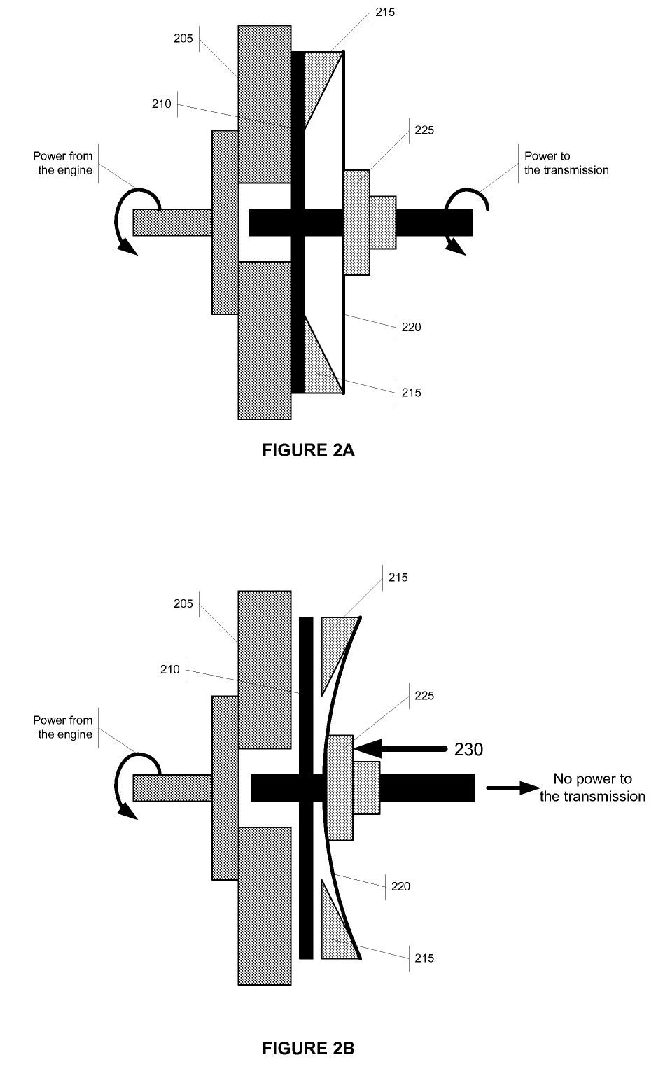

To increase the effectiveness of controlling the automobile speed remotely, an embodiment of the present system includes transmission manipulation. The RCS (130) may include an automobile shut down signal. While the automobile could be shut down by cutting the engine off completely from its air and/or fuel supply, it may be more effective to cut the engine off in conjunction with disengaging the transmission. As discussed above, the CPU (110) may receive a RCS (130) that mandates the automobile to shut down using the automobile speed control device (120) and/or using the automobile transmission disengagement device (125). The automobile speed control device and its corresponding signal have already been discussed above. The ATDS (145) may be sent to the automobile transmission disengagement device (125) to disengage the transmission. The implementation of the disengagement device depends on the type of transmission. If the automobile contains a manual transmission, then the disengagement device could be implemented by kicking out the clutch such that the transmission no longer receives power from the engine. FIG. 2A illustrates the component of a manual clutch and their relative positions when the clutch is engaged. The flywheel (205) is connected to the drive shaft of the motor, and clutch plate (210) is sandwiched between the flywheel (205) and the pressure plate (215), and is connected to the transmission shaft. While these three structured are sandwiched (i.e., the clutch is engaged), the power from the engine is transferred to the transmission. FIG. 2B illustrates the clutch when it is no longer engaged. The diaphragm spring (220) is pushed by the throw-out bearing (225) in the direction of arrow 230, causing it to bow and release the pressure plate (215). Without the pressure of the pressure plate (215), the clutch plate (210) is also released, preventing the transfer of power from the engine to the transmission. Generally the throw bearing (225) is linked to the clutch pedal, such that depressing the pedal disengages the clutch. The transmission disengagement device could comprise a motor, solenoid, or other electromechanical device that depresses the throw bearing (225). The CPU (110) could send a signal to activate the motor, solenoid, or other electromechanical device, thus disengaging the clutch and, consequently the transmission.

Automatic transmissions operate in a much different manner. The torque converter takes the place of the clutch found on manual transmissions. The principle behind a torque converter is analogous to having two fans facing each other. One fan is powered such that its blades begin to turn. At first, the un-powered fan's blade will not move; however after a short while the un-powered fan's blades begin to turn as the blades receive the air stream from the powered fan and will continue to turn until it reaches about the same speed as that of the powered fan blades. Instead of air in the fan analogy, a torque converted uses transmission fluid to transfer power to the transmission (i.e., the un-powered fan) more efficiently. Cutting off the transmission fluid in the torque converter would prevent the transfer of power to the transmission. In fact, this is what is done by the transmission when it is shifted into park or neutral. Thus, the transmission disengagement mechanism could engage the existing pumps in the transmission to remove the transmission fluid. Alternatively, the disengagement system could contain its own transmission fluid pump system.

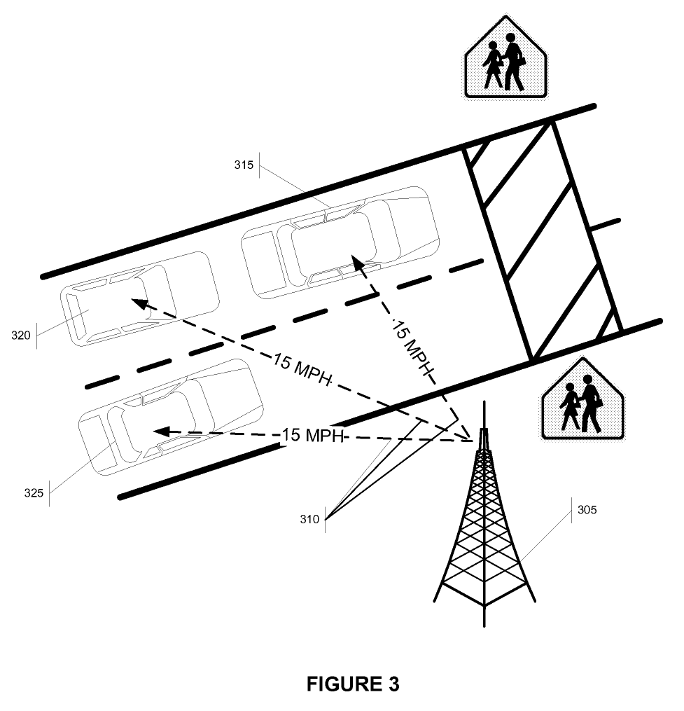

This system may be used in several applications. For example, the system may be used in safety corridors which may include mountainous area with several sharp turns, a construction area where construction personnel could be exposed and a school zone where children could be playing. Specifically referring to FIG. 3, a radio transmitter (305) could be place in an area where the speed should be regulated to increase safety. The transmitter would broadcast a signal (310) to the safety area such that vehicles 315, 320 and 325 entering the area would be prevented from exceeding the speed encoded on the signal (310)—which in this case would be 15 MPH.

The devices described herein could also be used to selectively control a particular vehicle. For example, in a HSP it may not be practical to broadcast a speed limiting signal to the entire corridor through which the pursuit is traveling. This could cause several vehicles to slow and the evading vehicle may attempt to evade by scrambling and hitting innocent vehicles. In this situation is may be more appropriate to target the evading vehicle with a signal that only affects that vehicle, which would give the innocent vehicles the speed and control to avoid an accident. This may be accomplished in several ways. For example, the speed signal may be sent by a unidirectional transmitter that is aimed directly at the evading vehicle. Because the evading vehicle is the only one to receive the signal, it will be the only one that responds to the signal and slows down. Alternatively, a signal could be broadcast, but the signal may be marked with a unique code that is keyed to the particular vehicle being pursued. An officer involved in the HSP could read the license plate of the evading vehicle. That license number would be used to construct the unique code that is broadcast such the evading vehicle would be the only vehicle acting upon the signal.

It is also possible that the license plate information may not be available or may not be reliable. In such a case, a semi-unique code may be broadcast to the HSP area. Specifically, the officer may be able to identify the make and model of the car and use that as a basis for the signal. This would be the basis for the signal, causing all cars with that make and model to act upon the signal. While innocent vehicles could theoretically act upon the signal, the chances are that few, if any, would be in the HSP area. It would be apparent to those skilled in that other methods could be used to identify the evading vehicle and construct a unique or semi-unique code.

Turning now to FIG. 4, the method for decoding the RCS and generating the appropriate signals will be disclosed. First, the CPU acquires the RCS and decodes it at steps 405 and 410. Then the CPU must determine whether the RCS is a unique code, a semi-unique code or a general code at the steps included in the shaded box 415. A general code is one that is acted upon by all vehicles receiving the signal. A unique or semi-unique code is one that is keyed to a single vehicle or a small group of vehicles as discussed above. If the CPU determines that it is a general code or that the specific vehicle is part of the group covered by the unique or semi-unique code then the CPU performs step 420 and determines whether the RCS contains an automobile shut down signal. If so, then the CPU sends the ATDS (145) to the automobile transmission disengagement device (125) at step 425. Optionally, at step 430 the CPU may send an ASCS (140) to the automobile speed control device (120) that cuts off the engine by cutting off the air supply and/or the fuel supply. If the RCS does not require the automobile to shut down, then the CPU needs to compare its present speed, as indicated by the ASSS (135), to the speed encoded on the RCS. This is done at step 435. If the vehicle's current speed is larger than the RCS encoded speed, then at step 440 the vehicle sends an ASCS to the automobile speed control device (120) to reduce the speed. This process is repeated until the desired speed is achieved, or until the duration encoded on the RCS elapses at step 440. Optionally, the RCS need not have a duration encoded because the broadcast of the signal may be area specific; meaning that once the vehicle is out of the range of the RCS then it would not need to act.

Having described the system in detail and by reference to several preferred embodiments thereof, it will be apparent that modifications and variations are possible without departing from the scope of the invention defined in the following claims. For example, while the embodiment above have been described with reference to automobiles, it would be apparent to one skilled in the art that the system described herein can be used in several personal vehicles including, but not limited to, boats, motorcycles, buses and RV's. Moreover, the applicants expressly do not intend that the following claims “and the embodiments in the specification to be strictly coextensive.” Phillips v. AHW Corp., 415 F.3d 1303, 1323 (Fed. Cir. 2005) (en banc).

1. A system for the remote control of a vehicle comprising:
an antenna adapted to receive a remote control signal;
a speed sensor that detects the speed of the vehicle and generate a speed sensor signal that encodes the speed of the vehicle;
a speed control device that regulates the speed of the vehicle in response to a speed control signal;
a central processing unit (CPU) connected to the antenna and adapted to receive the remote control signal, and connected to the speed sensor and adapted to receive the speed sensor signal; wherein the CPU generates the speed control signal by performing the following steps:
(a) decoding the remote control signal;
(b) determining the speed encoded on the remote control signal;
(c) comparing the speed encoded on the remote control signal to the speed encoded on the speed sensor signal;
(d) If the speed encoded on the speed sensor signal is larger than the speed encoded on the remote control signal, then generating the speed control signal encoded with instructions to reduce the vehicle speed; and
(e) continuing steps (c) and (d) until the speed encoded on the speed sensor signal is equal or less than the speed encoded on the remote control signal.

2. The system of claim 1, wherein the steps performed by the CPU further comprise:
(f) determining a duration for the speed encoded on the remote control signal; and
(g) performing steps (c) through (e) for the length of the duration.

3. The system of claim 1, wherein the CPU contains a register with a vehicle code that identifies the vehicle and wherein the remote control signal comprises a unique code, and wherein the steps performed by the CPU further comprise:
(h) CPU compares the vehicle code to the unique code; and
(i) if the vehicle code matches the unique code, then performing steps (b) through (e), otherwise not performing steps (b) through (e).

4. The system of claim 1, wherein the CPU contains a register with a vehicle code that identifies the vehicle and wherein the remote control signal comprises a semi-unique code, and wherein the steps performed by the CPU further comprise:
(h) CPU compares the vehicle code to the semi-unique code; and
(i) if the vehicle code matches the semi-unique code, then performing steps (b) through (e), otherwise not performing steps (b) through (e).

5. The systems of claim 1, wherein the speed control device is a throttle valve that responds to the speed control signal by closing the throttle valve.

6. The systems of claim 1, wherein the speed control device is a fuel pump that responds to the speed control signal by reducing the amount of fuel pumped.

7. The systems of claim 1, wherein the speed control device is a fuel line valve that responds to the speed control signal by closing the fuel line valve.

8. A system for remote control of a vehicle, wherein the vehicle comprises an engine and a transmission, the system comprising:
an antenna adapted to receive a remote control signal;
a transmission disengagement device that disengages power delivery from the engine to the transmission in response to a transmission disengagement signal;
a central processing unit (CPU) connected to the antenna and adapted to receive the remote control signal, and connected to the transmission disengagement device; wherein the CPU generates the transmission disengagement signal by performing the following steps:
(a) decoding the remote control signal;
(b) determining whether the remote control signal contains a vehicle shut down signal; and
(c) if the remote control signal contains a vehicle shutdown signal, then generating a transmission disengagement signal encoded with instructions to disengage power delivery from the engine to the transmission.

9. The system of claim 8, wherein the CPU contains a register with a vehicle code that identifies the vehicle and wherein the remote control signal comprises a unique code, and wherein the steps performed by the CPU further comprise:
(d) CPU compares the vehicle code to the unique code; and
(e) if the vehicle code matches the unique code, then performing steps (b) and (c), otherwise not performing steps (b) and (c).

10. The system of claim 8, wherein the CPU contains a register with a vehicle code that identifies the vehicle and wherein the remote control signal comprises a semi-unique code, and wherein the steps performed by the CPU further comprise:
(d) CPU compares the vehicle code to the semi-unique code; and
(e) if the vehicle code matches the semi-unique code, then performing steps (b) and (c), otherwise not performing steps (b) and (c).

11. The system of claim 8, wherein the vehicle further comprises a clutch and the transmission disengagement device disengages the clutch.

12. The system of claim 8, wherein the vehicle further comprises a torque converter and the transmission disengagement device disengages the torque converter.

13. The system of claim 8, wherein the system further comprises a speed sensor that detects the speed of the vehicle and generate a speed sensor signal that encodes the speed of the vehicle; and a speed control device that regulates the speed of the vehicle in response to a speed control signal; wherein the CPU further performs the following steps:
(d) decoding the remote control signal to determine the speed encoded on the remote control signal;
(e) if the remote control signal does not contain a vehicle shutdown signal as determined in step (b), then performing steps (f) through (h):
(f) comparing the speed encoded on the remote control signal to the speed encoded on the speed sensor signal; and
(g) If the speed encoded on the speed sensor signal is larger than the speed encoded on the remote control signal, then generating the speed control signal encoded with instructions to reduce the vehicle speed; and
(h) continuing steps (f) and (g) until the speed encoded on the speed sensor signal is equal or less than the speed encoded on the remote control signal.

14. The system of claim 13, wherein the steps performed by the CPU further comprise:
(i) determining a duration for the speed encoded on the remote control signal; and
(j) performing steps (f) through (h) for the length of the duration.

15. The systems of claim 13, wherein the speed control device is a throttle valve that responds to the speed control signal by closing the throttle valve.

16. The systems of claim 13, wherein the speed control device is a fuel pump that responds to the speed control signal by reducing the amount of fuel pumped.

17. The systems of claim 13, wherein the speed control device is a fuel line valve that responds to the speed control signal by closing the fuel line valve.
